(19) United States
(12) Patent Application Publication
(10) Pub. No.: US 2023/0234342 A1
(43) Pub. Date: Jul. 27, 2023

(54) PROCESS FOR THE APPLICATION OF A COVERING LAYER TO A POLYMERIC PRODUCT, DEVICE FOR CARRYING OUT SAID PROCESS AND PRODUCT MADE WITH SAID PROCESS

(71) Applicant: NEOS S.r.l., Fiorano Modenese (MO) (IT)

(72) Inventor: Vincenzo Palumbo, Fiorano Modenese (MO) (IT)

(73) Assignee: NEOS S.r.l., Fiorano Modenese (MO) (IT)

(21) Appl. No.: 17/918,968

(22) PCT Filed: Oct. 23, 2020
(86) PCT No.: PCT/EP2020/079905

§ 371 Date: Oct. 14, 2022

(30) Foreign Application Priority Data
Apr. 16, 2020 (IT) 102020000008026

(51) Int. Cl. B32B 27/08; B32B 7/12; B32B 27/30; B32B 37/00; B32B 38/00

(52) U.S. Cl. CPC B32B 27/08; B32B 7/12; B32B 27/304; B32B 37/0053; B32B 38/145; B32B 2038/0076; B32B 2250/02; B32B 2250/246; B32B 2255/10; B32B 2305/72; B32B 2307/4023; B32B 2310/0831; B32B 2327/06

(57) ABSTRACT

Process for the application of a covering layer to a polymeric product (10), in particular a sheet or a panel, comprising the steps of: —providing a planar substrate (11) of polymeric material, with an ink layer (12) deposited on a surface of said planar substrate (11) to define a printing pattern; —applying, above said ink layer (12), an interface layer in a respective application station (3); —applying a covering layer (14) of transparent polymeric material, above said interface layer and as a protection of the printing pattern in a respective rolling station (4).

### FIELD OF APPLICATION

The present invention relates to a process for the application of a covering layer to a polymeric product, for instance a polyvinylchloride (PVC) sheet or panel. The covering layer is in particular arranged for the protection of a printed graphic on the polymeric product.

The invention also relates to a device for carrying out the above process and to the sheet or panel thus made.

The invention may find useful application in various technological fields where the printed decoration of a polymeric support is required.

For instance it may be usefully employed in making polymeric sheets. These sheets are usually used for the decorative coating of surfaces.

In making vinyl floors, for instance, a PVC decorative sheet that reproduces a wooden, stone or metal surface is coupled by calendaring or pressing on a support base that defines the panel body.

Similar decorative applications of polymeric sheets may be provided for instance on PVC window frames or baseboards.

### PRIOR ART

The thermoplastic sheets of the above-identified type are made from a substrate, usually white PVC, whereon a decorative pattern is printed. The substrate is then covered by a further transparent PVC layer, with the function of protection of the printed pattern.

The above-described configuration is schematically represented in FIG. 1, that illustrates a thermoplastic sheet 10′ made according to a prior art method.

As above stated, the thermoplastic sheet 10′ has a PVC substrate 11, over which the ink layer 12 that defines the printed decoration is deposited. The subsequent covering layer 14, of transparent PVC, is applied by hot rolling, at temperatures indicatively comprised between 150° C. and 170° C., onto the ink layer 12 and it guarantees the durability over time thereof, thus preventing abrasion phenomena.

However, the production processes known to date are limited from the type of ink used in making the printed decoration. In particular, these processes may be effectively used only if the printing is made with certain solvent-based inks.

On the other hand, it has been found that other printing inks, such as the U.V. inks, form a barrier to the adhesion between the two PVC layers. Due to this barrier effect, the rolling step does not ensure a stable and durable application of the transparent coating layer and the resulting quality of the product is not enough for a commercial distribution thereof.

The above barrier effect has been found with the main inks adopted in the digital printing.

An exception is represented by the solvent-based inks, which however imply risks for the health of operators due to their known carcinogenic properties.

Other suggested techniques for the use of inks for digital printing of another type require a specific preparation of the substrate, with considerable installation costs.

For the above reasons, to date the thermoplastic sheets equipped with a protective coating layer are mainly obtained with analogic printing. This results in a substantial limitation in the industrial field, where the digital printing is progressively establishing itself due to the way it combines the speed of processing with the absolute flexibility in the choice of the images and/or of the printing patterns.

Therefore, the technical problem underlying the present invention is to provide a process for the application of a covering layer to a polymeric product, in particular to a sheet or panel, which extends the compatibility of the prior art processes to other types of ink, suitable for the digital printing.

### SUMMARY OF THE INVENTION

The previously identified technical problem is solved by a process for the application of a covering layer to a polymeric product comprising the steps of:
providing a planar substrate of polymeric material, preferably of a neutral colour, for instance white, with an ink layer deposited on a surface of said planar substrate to define a printing pattern;
applying, above said ink layer, an interface layer;
applying a covering layer of transparent polymeric material, above said interface layer and as a protection of the printing pattern.

It should be noted that, in the wording used in the present description and in the claims, the ink layer does not necessarily imply a complete covering of the planar substrate, since areas not interested by the deposit of ink drops are possible.

The application of the interface layer prevents a direct contact between ink and covering layer. Thus the barrier effect is prevented, which, in the prior art processes, prevents a satisfactory adhesion of the covering layer on certain inks, preferentially used in the digital printing, such as for instance the U.V. inks or the water-based inks.

The polymeric product made with the process is preferably a polymeric sheet, which may be subsequently used for instance to decorate a paving panel.

The polymeric product may also be an already formed thermoplastic panel; in this case it is preferable to continuously feed the panel and then to roll it with the covering layer, to subsequently carry out a cutting step of the panel itself.

In a preferred embodiment of the present invention, the step of providing a planar substrate comprises a step of digital printing in which the ink layer is deposited, said step of digital printing being carried out in-line with the subsequent steps of applying the interface layer and of applying the covering layer.

In other words, the decorated sheet or panel is made with a single machinery, the post-process step with the application of the covering layer being provided directly at the exit of the digital printer.

Preferably, to improve the adhesion of the multi-layered product the interface layer comprises at least one adhesive substance.

The adhesive substance may be a polymerizable adhesive substance, since in this case a step of polymerizing said interface layer subsequent to the application of the covering layer is provided.

Advantageously, in said polymerization step the interface layer is exposed to an ultraviolet light, which may be carried out continuously at the exit of the application station for applying the covering layer.

Preferably, said polymerization of the interface layer is carried out by means of a LED lamp, which concentrates the peak of power at a specific wavelength, comprised between 385 nm and 405 nm.

In a preferred embodiment of the present invention, the planar substrate and the covering substrate are both made of polyvinylchloride.

On the other hand, it is noted that the two polymeric materials that constitute the planar substrate and the covering layer may also be different with respect to PVC; it is still noted that the two substrate and covering materials are not necessarily the same, since a PVC substrate and a covering of another material or vice versa may be provided.

Advantageously, the step of applying the covering layer is made by rolling. The covering layer is thus continuously fed and superimposed on the planar substrate through rolling calenders that determine the cohesion thereof.

Preferably the rolling that applies the covering layer is a cold rolling. As previously stated, the presence of the intermediate ink layer prevents anyway the coupling of the two softened plastic materials, and the heating is thus unnecessary. Instead the presence of the adhesive of the interface layer ensures the coupling between the layers.

Preferably, the ink layer comprises a U.V. ink, the process further comprising a step of fixing the ink layer through exposure to ultraviolet light, said step being prior to the step of applying the interface layer.

In case another ink is used, for instance a water-based ink, a different ink-fixing device may be provided at the same station, for instance a drying station.

Preferably, the interface layer is applied through an application roller, which may be opposite a return roller. Within the two rollers the planar substrate is made to slide continuously.

In an alternative embodiment, the interface layer may be applied directly at the digital printer, for instance by means of a dedicated printed module.

As previously mentioned, the steps of depositing the ink layer, of applying the interface layer and of applying the covering layer are carried out in-line, namely continuously on the planar substrate moving along a forward direction.

The above-identified technical problem is also solved by a device for applying a covering layer to a polymeric product, in particular a sheet or a panel, comprising: means for moving forward a planar substrate of polymeric material, with an ink layer deposited on a surface thereof so as to define a printing pattern, along a forward direction; an application station for applying an interface layer above said planar substrate; and a rolling station for rolling a covering layer of transparent polymeric material on the planar substrate placed downstream of said application station.

Preferably, said device still comprises a digital printer for the deposition of the ink layer above the forward-moving planar substrate, placed in-line upstream of said application and rolling stations.

The different stations are preferably integrated in a same device, so as to provide a compact and reduced-size machine.

The above device may further comprise a polymerization station for polymerizing the interface layer, which may be for instance an ultraviolet lamp, placed downstream of the rolling station.

The above-outlined technical problem is also solved by a polymeric product, in particular sheet or panel, comprising: a planar substrate of polymeric material; an ink layer defining a printing pattern directly in contact with a surface of said planar substrate; a covering layer of transparent polymeric material placed above said ink layer and as a protection of the printing pattern; and an interface layer interposed between the ink layer and the covering layer.

Preferably, the ink layer comprises a U.V. ink and the interface layer comprises a polymerizable adhesive.

Further features and advantages will become more apparent from the detailed description made below of a preferred non-limiting embodiment of the present invention, with reference to the attached figures, given for illustrating but not limiting purposes.

### BRIEF DESCRIPTION OF THE DRAWINGS

FIG. 1 shows a schematic view, with altered proportions in order to highlight the aspects of interest, of a polymeric product, in particular a PVC sheet, made according to the prior art;

FIG. 2 shows a schematic view, with altered proportions in order to highlight the aspects of interest, of a polymeric product, in particular a PVC sheet, made according to the present invention;

FIG. 3 schematically illustrates a device for implementing the process for applying the covering layer according to the present invention.

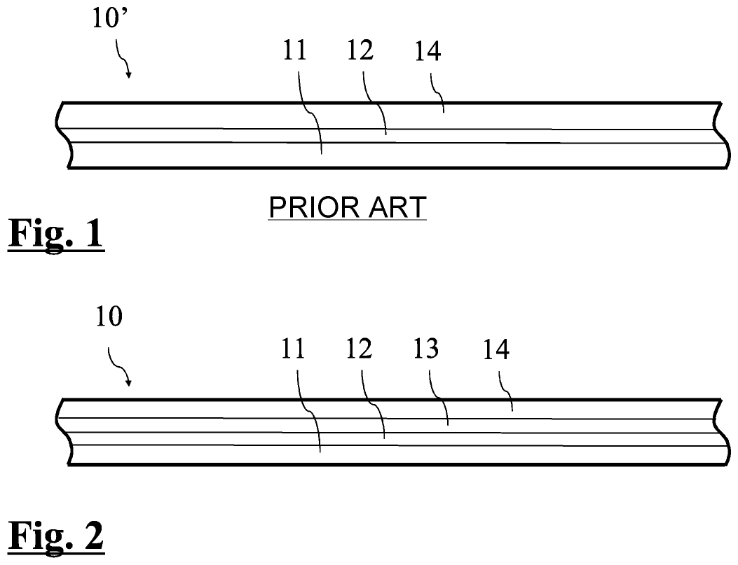

### DETAILED DESCRIPTION

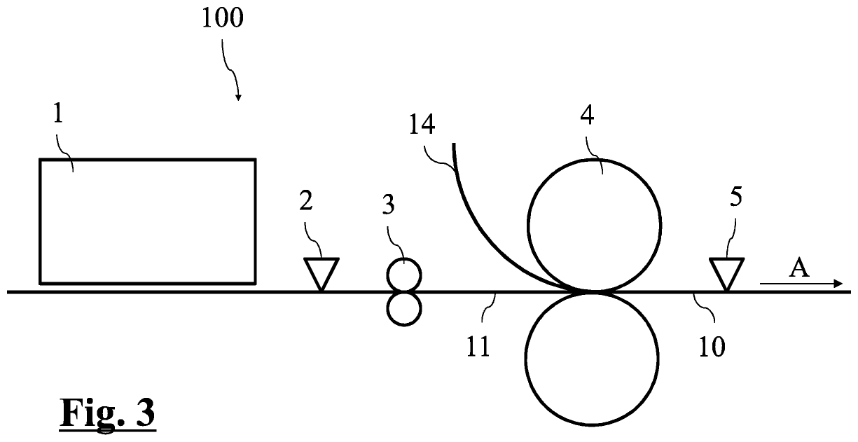

With reference to the attached FIG. 3, reference number 100 wholly indicates a device for the application of a covering layer to a polymeric product 10, in particular a PVC sheet.

In the following description, terms such as on, under, below, upper, or derivatives thereof are to be intended with reference to the normal configuration of use of the device 100 illustrated in the above-mentioned figure.

The device 100 provides forward means, not represented since they are per se known, for moving forward a PVC planar substrate 11, of a neutral colour (for instance white), along the different process stations.

A first process station is represented by a digital printer 1, schematically illustrated in the above figure.

In a per se known manner the digital printer has one or more printing modules, for instance four printing modules relating to the different colours of a four-color printing. Each module comprises one or more printing heads arranged to release ink drops onto the planar substrate 11 which passes there below.

In the decoration process according to the prior art, a printing pattern is thus made on the upper surface of the planar substrate 11. The printing pattern is identified in the present description as an ink layer 12.

The above printing pattern may represent for instance a wooden, stone or metal appearance, so that the resulting polymeric sheet will constitute the decorative coating for instance of a flooring vinylic panel.

The inks dispensed by the digital printer 1 are preferably U.V. inks, and a fixing station 2 for fixing the colour constituted in this case by an ultraviolet light lamp is consistently placed at the exit.

A different fixing station 2 may be provided according to the type of ink used. In the case of a water-based ink, for instance, a drying station may be provided. The drying station may be constituted, in a per se known manner, by a hot air oven or an I.R. dryer.

Downstream of the fixing station 2 an application station 3 for applying an interface layer 13 is provided. Said station may be formed by an application roller and an opposite return roller, wherein the application roller is fed with a polymerizable adhesive substance that constitutes the above interface layer 13.

At this station, the process thus provides for the application of the interface layer 13, which covers the planar substrate 11 by overlapping the printing pattern defined by the ink layer 12.

Subsequently to the application station 3 a rolling station 4 is provided, which is constituted in a per se known manner by two rolling calenders.

In this station, the process provides for the coupling to the planar substrate 11 of a covering layer 14, fed continuously. The covering layer 14 in the present embodiment is a PVC transparent film, that protects the previously made printing pattern. The interface layer 13 is that between the planar substrate 11 and the covering layer 14, as visible in FIG. 2.

Finally, the device provides a last polymerization station 5 for polymerizing the interface layer 13, placed at the exit of the above rolling rollers 4.

The polymerization station 5 may be an ultraviolet light lamp. Preferably, for the polymerization station 5 a LED lamp is used, which concentrates the peak of power to a specific wavelength, comprised between 385 nm and 405 nm according to the project choices. Actually, it has been verified that PVC, generally impermeable to ultraviolet light, has a minimum permeability around said wavelengths.

In the polymerization station 5 a polymerization step for polymerizing the interface layer is carried out, in which the adhesive substance used reticulates, thus defining an integral and stable coupling between planar substrate 11 and covering layer 14, though the interposed presence of U.V. ink drops.

Obviously, a skilled person can make several changes and variants to the above described invention, in order to meet contingent and specific needs, all of them by the way contained in the scope of protection of the invention as defined by the following claims.

1. A process for the application of a covering layer to a polymeric product, in particular a sheet or a panel, comprising the steps of:
providing a planar substrate of polymeric material, with an ink layer deposited on a surface of said planar substrate to define a printing pattern;
applying, above said ink layer, an interface layer;
applying a covering layer of transparent polymeric material, above said interface layer and as a protection of the printing pattern.

2. The process according to claim 1, wherein said interface layer comprises at least one adhesive substance.

3. The process according to claim 2, wherein said adhesive substance is a polymerizable adhesive substance, the process further comprising a step of polymerizing said interface layer.

4. The process according to claim 3, wherein said step of polymerizing the interface layer is subsequent to the step of applying the covering layer.

5. The process according to claim 4, wherein in said step of polymerizing the interface layer it is exposed to an ultraviolet light.

6. The process according to claim 1, wherein said planar substrate and the covering layer are both made of polyvinylchloride.

7. The process according to claim 1, wherein said step of applying the covering layer is made by rolling.

8. The process according to claim 7, wherein said rolling that applies the covering layer is a cold rolling.

9. The process according to claim 1, wherein said ink layer comprises a U.V. ink.

10. The process according to claim 1, wherein the interface layer is applied through an application roller.

11. The process according to claim 1, wherein said step of providing the planar substrate comprises a step of digital printing in which the ink layer is deposited, said step of digital printing being carried out in-line with the subsequent steps of applying the interface layer and of applying the covering layer.

12. A device for applying a covering layer to a polymeric product, in particular a sheet or a panel, comprising:
means for moving forward a planar substrate of polymeric material, with an ink layer deposited on a surface thereof to define a printing pattern, along a forward direction;
an application station for applying an interface layer above said planar substrate; and
a rolling station for rolling a covering layer of transparent polymeric material on the planar substrate placed downstream of said application station.

13. The device according to claim 12, further comprising a digital printer for depositing the ink layer above the forward-moving planar substrate, placed in-line downstream of said application and rolling stations.

14. A polymeric product, in particular a sheet or a panel, comprising:
a planar substrate of polymeric material;
an ink layer defining a printing pattern directly in contact with a surface of said planar substrate;
a covering layer of transparent polymeric material placed above said ink layer and as a protection of the printing pattern; and
an interface layer interposed between the ink layer and the covering layer.

15. The polymeric product according to claim 14, wherein said ink layer comprises a U.V. ink and said interface layer comprises a polymerizable adhesive.
